(19) United States
(12) Patent Application Publication
(10) Pub. No.: US 2020/0320535 A1
(43) Pub. Date: Oct. 8, 2020

(54) METHOD FOR SECURING AN ELECTRONIC DEVICE AND CORRESPONDING ELECTRONIC DEVICE

(71) Applicant: IDEMIA FRANCE, COLOMBES (FR)

(72) Inventors: Francis CHAMBEROT, Colombes (FR); Marco DE OLIVEIRA, Colombes (FR)

(21) Appl. No.: 16/304,235

(22) PCT Filed: May 22, 2017
(86) PCT No.: PCT/FR2017/051254

§ 371 Date: Nov. 23, 2018

(30) Foreign Application Priority Data
May 23, 2016 (FR) 1654572

(51) Int. Cl. G06Q 20/40; G06Q 20/34; G07F 7/12; G07F 7/10

(52) U.S. Cl. CPC G06Q 20/4016; G07F 7/1008; G07F 7/12; G06Q 20/341

(57) ABSTRACT

A security method performed by an electronic device (CD) and the electronic device. The method includes determining a current time point during which a current transaction is carried out; selecting, from a log file (LG) in which at least one past transaction is stored, each transaction carried out by the electronic device (CD) during a predefined time period terminating at the current time point; analyzing risk from log data stored in the log file in association with each selected transaction in order to detect whether an abnormal use of the electronic device (CD) has occurred during the predefined time period; and if so, triggering at least one security operation for the electronic device (CD) in response to the current transaction.

### CROSS-REFERENCE TO RELATED APPLICATIONS

This application is a U.S. National Stage application of International Application No. PCT/FR2017/051254 filed 22 May 2017, which claims priority to French Application No. 1654572 filed 23 May 2016, the entire disclosures of which are hereby incorporated by reference in their entireties.

### BACKGROUND OF THE INVENTION

The present invention lies in the general field of electronic devices, and it relates more particularly to an electronic device, e.g. such as a smart card, that is configured to co-operate with an external terminal in order to perform a transaction, e.g. in the field of banking.

The invention applies more particularly, but in non-exclusive manner, to smart cards (or microcircuit cards) that comply with the ISO 7816 standard, for example. The invention relates in particular to making secure a smart card operating in compliance with the Europay Mastercard Visa (EMV) protocol.

In general manner, a smart card is designed to communicate with a device that is external to the card, otherwise known as a terminal or reader. Such cards enable various types of transaction to be carried out, such as for example payment transactions, direct debit transactions, or indeed authentication of the bearer. By way of example, smart cards for banking applications (credit cards, debit cards, etc.) are suitable for co-operating with payment terminals or with automatic teller machines (ATMs) in order to perform various financial operations.

EMV is the standardized protocol that is nowadays in the most widespread use throughout the world, in particular for securing payment transactions carried out with smart cards.

The EMV protocol was designed to reduce the risk of fraud during a payment transaction, in particular by making it possible to authenticate both the smart card and its bearer. The authentication process relies on a combination of cryptograms (or encrypted keys) and of digital signatures, and it optionally requires the bearer of the card to input a secret code (commonly referred to as a personal identification number (PIN)).

Depending on the type of card used, on the situation, or indeed the amount in question, an EMV card may operate on-line or off-line. In on-line mode, the EMV card may communicate via the reader with the corresponding issuing entity (the bank from which the card originates, for example) in order to verify in particular that the current transaction is legitimate. In contrast, if the EMV card is operating in off-line mode, it applies previously-stored verification criteria in order to decide whether the transaction is to be authorized or refused.

FIG. 1 shows an example of a payment transaction being carried out in compliance with the EMV protocol using an EMV smart card 100. Certain aspects of an EMV transaction are omitted for reasons of simplicity.

While carrying out a transaction, the EMV protocol is organized in three stages, although variants are also possible. During a first stage for authenticating the smart card 100 in use, the terminal 110 and the card 100 exchange a certain number of messages including a RESET message (RST) during S2 followed by an ATR response during S4. During S6, the bearer of the card uses the terminal 110 to select the desired transaction mode, thus causing a “SELECT” command to be sent to the card 100 in order to initiate the beginning of the EMV transaction.

Once the stage of authenticating the card has been completed, the EMV protocol proceeds with a stage (not shown) of authenticating the bearer of the card 100. The terminal 100 determines which bearer authentication method to apply, and in particular it determines whether the transaction is to be carried out in a mode with code verification or in a mode without code verification. If the code verification mode is selected, the smart card 100 verifies the validity of the PIN code input by the bearer to the terminal 110. In contrast, if the mode without code verification is selected, no PIN code verification is performed.

Once the stage of authenticating the bearer has been completed, the EMV protocol initiates a stage of verifying the transaction. To do this, the terminal 110 sends (S8) to the smart card 100 a first APDU command known as GENERATE AC or GAC (written herein GAC1). This well-known command includes information about the current transaction, such as the amount of the transaction, the currency used, the type of transaction, etc. The EMV card then verifies (S9) the transaction using predefined verification criteria, and then sends (S10), in response to the GAC1, a cryptogram (or cryptographic certificate) including a message authentication code (MAC). The response of the card 100 in the ARQC message depends in particular on how the card was set up by the entity 120 that issued said card (referred to as the “issuer”).

If the on-line mode is selected, as shown in the example of FIG. 1, the smart card 100 sends during S10 an authorization request cryptogram (ARCQ) type message indicating that the card 100 seeks to continue the transaction on-line, e.g. with a remote server of the issuer 120 (on-line mode). The ARCQ cryptogram is transmitted by the terminal 110 to the issuer 120, which can thus perform (S13) various verifications in order to ensure that the transaction is valid. Thereafter, the issuer 120 responds to the received ARCQ message, by sending (S14) an encrypted ARPC type message giving the decision of the issuer 120. This ARPC message is transmitted by the terminal 110 to the card 100 during S16.

The card 100 determines whether or not it accepts the transaction on the basis of the ARPC response received during S16. If the card 100 accepts the transaction, it responds by sending (S18) a transaction accepted (TC) type cryptogram to the terminal 110. Otherwise, the card 100 sends (S18) an AAC type cryptogram indicating that the transaction is refused. Performing a transaction on-line thus makes it possible to implement security mechanisms serving to identify risky situations and to trigger an appropriate security response. The issuer of the smart card may for example detect abnormal behavior during an on-line transaction and then decline the transaction or trigger additional verification checks.

Present EMV cards are generally configured so as to be capable of performing a certain number of transactions off-line, so that it is not possible for the entity issuing the card to perform a remote security check during an off-line transaction. By way of example, certain EMV cards are configured to operate off-line if the amount of the current transaction does not reach a predefined minimum amount.

Smart cards, and in particular EMV cards, are thus particularly vulnerable to attack and malicious (or abnormal) behavior when they operate off-line. By way of example, if an EMV card is stolen, the thief can then perform numerous successive transactions all for small amounts so as to avoid triggering on-line operation of the card, and thus escape from the vigilance of the card issuer.

There thus exists at present a need for a security mechanism that enables smart cards, e.g. cards of the EMV type, to be protected effectively against abnormal and/or suspect behaviors taking place, in particular during off-line transactions. Greater security is necessary in particular for protecting smart cards against fraudulent use, e.g. in the event of theft. More generally, a need exists for better monitoring of the use of an electronic device such as a smart card for example (of EMV or other type), including when the device is operating off-line in order to carry out a transaction.

### OBJECT AND SUMMARY OF THE INVENTION

To this end, the invention provides a security method performed by an electronic device, said method comprising:
determining a current time point during which a current transaction is or is to be carried out by the electronic device;
selecting, from a log file in which at least one past transaction is stored, at least one (or each) transaction carried out by said electronic device during a predefined time period terminating at the current time point;
analyzing risk from log data stored in the log file in association with each selected transaction in order to detect whether an abnormal use of said electronic device has occurred during said predefined time period; and
if so, triggering at least one security operation for the electronic device in response to said current transaction.

In this example, the predefined time period is a moving time period that terminates at the current time point.

The present invention serves advantageously to provide electronic devices with protection that is effective, and in particular to do so with smart cards (of EMV or other type) that are configured to co-operate with a terminal in order to carry out a transaction (a bank or other transaction).

The invention serves in particular to make such electronic devices secure against abnormal or suspect behaviors occurring during off-line transactions.

In a particular implementation, the current time point comprises at least one of the current date and the current time of the current transaction.

In a particular implementation, determining the current point comprises receiving time data representative of the current time point from a terminal with which the electronic device is co-operating.

In a particular implementation, said selection comprises calculating the time point for the beginning of the predefined time period from the current time point and from a predefined duration given to said predefined time period;

each transaction that is selected being later than the time point for the beginning of the predefined time period.

In a particular implementation, during said selection, the electronic device:
determines from the log file and as a reference transaction, the most recent transaction in the predefined time period that satisfies at least a first predefined condition; and
selects only the transactions carried out by said electronic device subsequent to said reference transaction in the predefined time period.

In a particular implementation, said at least one first predefined condition comprises at least one of the following conditions:
the reference transaction is an “on-line” transaction that was carried out in co-operation with an issuer entity that issued the electronic device; and
the reference transaction is a “on-line” transaction that was successfully authenticated by the issuer entity that issued the electronic device.

In a particular implementation, during said selection, the electronic device filters the transactions stored in the log file so as to select only those transactions that satisfy at least one second predefined condition.

In a particular implementation, the second predefined condition comprises a condition about the type of terminal with which the electronic device co-operated during said transactions.

In a particular implementation, during said risk analysis, the electronic device detects whether abnormal use of said electronic device has taken place during said predefined time period on the basis of at least one of the following:
the number of transactions selected; and
the total accumulated amount of the selected transaction.

In a particular implementation, during said risk analysis, the electronic device detects that an abnormal use has occurred during said predefined time period if at least one of the following third predefined conditions is satisfied:
the number of transactions selected during said selection reaches a first predefined threshold value; and
the total accumulated amount of the transactions selected said during said selection reaches a second predefined threshold value.

In a particular implementation, said at least one security operation comprises at least one of the following:
sending a message providing information about said detected abnormal use;
modifying at least one operating parameter of the electronic device;
storing in the log file security data that represents said detected abnormal use; and
refusing to carry out said current transaction.

In a particular implementation, the electronic device is a smart card.

In a particular embodiment, the various steps of the security method are determined by computer program instructions.

Consequently, the invention also provides a computer program on a data medium (or recording medium), the program being suitable for being implemented in an electronic device such as a smart card, the program including instructions adapted to implementing steps of a security method as defined above.

The computer program may use any programming language, and be in the form of source code, object code, or code intermediate between source code and object code, such as in a partially compiled form, or in any other desirable form.

The invention also provides a computer-readable data medium (or recording medium) that includes instructions of a computer program as mentioned above.

The data medium may be any entity or device capable of storing the program. For example, the medium may comprise storage means, such as a read only memory (ROM), e.g. a compact disk (CD) ROM or a microelectronic circuit ROM, or indeed magnetic recording means, e.g. a floppy disk or a hard disk.

Furthermore, the data medium may be a transmissible medium such as an electrical or optical signal suitable for being conveyed via an electrical or optical cable, by radio, or by other means. The program of the invention may in particular be downloaded from an Internet type network.

Alternatively, the data medium may be an integrated circuit in which the program is incorporated, the circuit being adapted to execute or to be used in the execution of the method in question.

The invention also provides an electronic device comprising:
a determination module for determining a current time point during which a current transaction is or is to be carried out by the electronic device;
a selection module for selecting in a log file that stores at least one past transaction, at least one (or each) transaction carried out by said electronic device in a predefined time period that terminates at the current time point;
a risk analysis module for detecting, from log data stored in the log file in association with each selected transaction, whether an abnormal use of said electronic device has taken place during said predefined time period; and
a security module configured, in the event of a positive result of said detection by the risk analysis module, to trigger a security operation for the electronic device in response to said current transaction.

In this example, the predefined time period is a moving time period terminating at the current time point.

In a particular implementation, the invention is performed by means of software and/or hardware components. In this context, the term “module” may correspond in this document equally well to a software component, to a hardware component, or to a combination of hardware and software components.

In a particular embodiment, the electronic device is a smart card, e.g. of EMV type. In a particular embodiment, the smart card complies with the ISO 7816 standard.

In a particular embodiment, the electronic device of the invention includes a memory in which the log file is stored.

It should be observed that the various implementations mentioned above with respect to the security method of the invention and also the associated advantages apply in analogous manner to the electronic device of the invention.

### BRIEF DESCRIPTION OF THE DRAWINGS

Other characteristics and advantages of the present invention appear from the following description made with reference to the accompanying drawings, which show implementations having no limiting character. In the figures:

FIG. 1, described above, is a diagram showing a transaction carried out using the EMV protocol;

FIGS. 2A and 2B are diagrams showing a first security mechanism for an EMV smart card;

FIG. 3 is a diagram showing the structure of a smart card in a particular embodiment of the invention;

FIG. 4 is a diagram showing modules implemented in the FIG. 3 smart card, in a particular embodiment of the invention;

FIG. 5 is a flow chart showing the steps of a security method in a particular implementation of the invention;

FIG. 6 shows a log file in a particular embodiment of the invention;

FIG. 7 is a diagram showing transactions performed over time by the FIG. 3 smart card, in a particular implementation; and

FIG. 8 is a flow chart showing the steps of a security method in a particular implementation of the invention.

### DETAILED DESCRIPTION OF IMPLEMENTATIONS

As mentioned above, the present invention relates to electronic devices, e.g. such as smart cards, that are configured to co-operate with an external terminal in order to carry out a transaction, e.g. in the field of banking.

The invention relates more particularly to making configured smart cards secure, in particular when they are configured to carry out a transaction off-line, as explained above.

FIGS. 2A and 2B show a first security mechanism for a smart card 130 of EMV type. In this example, the smart card 130 is configured to calculate the total accumulated amount of transactions TR that it has successfully carried out during a fixed period of time CL referred to as a “cycle”, and then to verify whether this total amount reaches a maximum threshold value. This period of time CL begins at a fixed position (or point) in time DRef, referred to as the reference time position, e.g. corresponding to the date of a given transaction TR1. The time period CL also terminates at a fixed position in time DF.

In the example shown in FIG. 2A, during the transaction TR4, the EMV card 130 verifies the total accumulated amount of the transactions TR1, TR2, and TR3 carried out beforehand during a given cycle CL, together with the amount of the current transaction TR4. If the total amount reaches at least the maximum threshold value, then the card 130 may for example request to continue in on-line mode. Thereafter, when the card 130 detects a new transaction taking place after the instant DF, it reinitializes the reference point DRef in order to initialize a new time cycle CL that is likewise of fixed duration.

Nevertheless, that technique presents a drawback insofar as it is not always possible to detect a large and potentially abnormal increase in the amounts of transactions.

As shown in FIG. 2B, it is assumed by way of example that the smart card 130 was stolen at an instant V and that the thief carries out successive transactions TR1 -TR5 in a relatively short time interval. Assuming that the amount of each transaction remains below the maximum threshold authorized in off-line mode, it is not certain that the card 130 is capable of detecting the abnormal behavior that results from the theft, in spite of the security mechanism described with reference to FIG. 2A.

FIG. 2B shows an example in which the card 130 carries out transactions TR1 and TR2 during a first cycle CL1 and then initiates a new cycle CL2 during which it carries out transactions TR3-TR5. By way of example, during the transaction TR5, the smart card 130 verifies the total amount of transactions TR3, TR4, and TR5 included in the cycle CL2, but does not take account of the transactions TR1 and TR2 since both transactions were carried out during the preceding cycle CL1. The transactions TR1-TR5 being spread out over time in two distinct cycles CL1-CL2 thus increases the risk of these off-line transactions not being identified by the card 130 as constituting behavior that is abnormal or suspect.

The invention specifically proposes mitigating these drawbacks by using a security mechanism that makes it possible to detect abnormal or suspect behaviors effectively, including when the smart card is operating in off-line mode, so that an appropriate security response can be applied, where necessary.

In various implementations, the method of the invention performed by an electronic device such as a smart card, for example, comprises the following steps: determining a current time point during which a current transaction is or is to be carried out by the electronic device; selecting, from a log file in which at least one (or each) past transaction is stored, at least one transaction carried out by said electronic device during a predefined time period terminating at the current time point; analyzing risk from log data stored in the log file in association with each selected transaction in order to detect whether an abnormal use of said electronic device has occurred during said predefined time period; and if so, triggering at least one security operation for the electronic device in response to said current transaction.

The invention also provides such an electronic device suitable for performing the above-defined security method.

Other aspects and advantages of the present invention appear from the implementations and embodiments described below with reference to the above-mentioned drawings.

In the present disclosure, implementations of the invention are described with reference to a smart card of the EMV type. It should be understood that the invention is not limited exclusively to EMV cards, but that it applies more generally to any electronic device configured to carry out a transaction, including devices other than smart cards, the device possibly using the EMV standard, or other transaction standards.

In a particular example, the electronic device of the invention is a smart card complying with the ISO 7816 standard.

It should also be observed that the concept of a “transaction” should be understood broadly herein and includes, by way of example, in the field of banking, not only a payment transaction or a transfer transaction, but also consulting a bank account on a bank terminal. The various implementations of the invention are described herein in the context of a payment card configured to perform bank transactions. It should be understood that other types of transaction or operation can be envisaged in the ambit of the invention.

Unless indicated to the contrary, elements that are common or analogous in a plurality of figures are given the same reference signs and present characteristics that are identical or analogous, such that these common elements are generally not described again, for reasons of simplicity.

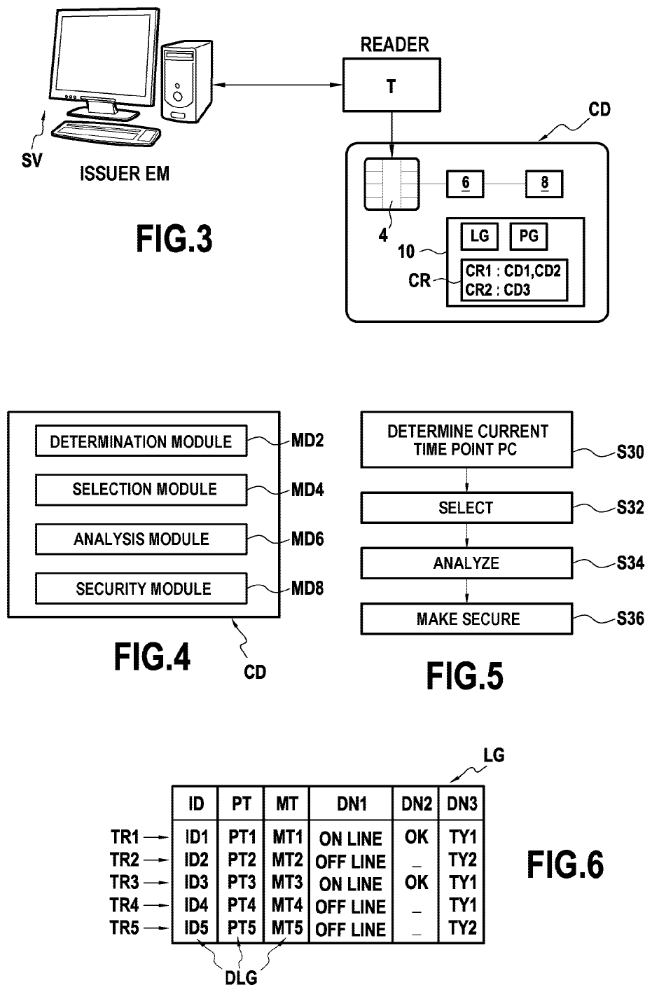

FIG. 3 is a diagram showing the structure of a smart card CD in accordance with a particular embodiment of the invention.

It should be understood that certain elements that are generally present in a smart card are voluntarily omitted since they are not necessary for understanding the present invention. It should also be observed that the smart card CD shown in FIG. 3 is merely one embodiment, and others are possible within the ambit of the invention. In particular, persons skilled in the art will understand that certain elements of the smart card CD are not described herein in order to facilitate understanding the invention, since those elements are not necessary for implementing the invention.

The smart card CD is configured to co-operate with a terminal (or reader) T in order to perform a transaction TR, such as a financial or bank transaction (payment or other transaction) in the present example.

The terminal T is configured to act as an interface between the smart card CD and a remote server SV. In the present example, the server SV is a server of the entity EM (e.g. a banking institution) that issues the smart card CD. In this example, the card CD is capable of communicating via the terminal T with the remote server SV in order to use the EMV protocol to carry out a so-called “on-line” transaction, i.e. a transaction involving an exchange with the issuer EM as explained above.

More precisely, the smart card CD in this example has external contacts 4 suitable for co-operating with the reader T, at least one processor 6, a volatile rewritable memory of the random access memory (RAM) type 8, and a non-volatile rewritable memory 10 (e.g. of the flash type).

In this example, the memory 10 constitutes a data medium (or recording medium) in accordance with a particular embodiment that is readable by the smart card CD and that stores a computer program PG in accordance with a particular embodiment. The computer program PG includes instructions for executing steps of a security method in a particular implementation. The main steps of the method in particular implementations of the invention are shown in FIGS. 5 and 8, as described below.

In a particular embodiment, the smart card CD complies with the ISO 7816 standard. Under such circumstances, the external contacts 4 present characteristics complying with that standard. Nevertheless, it should be understood that other embodiments are possible. By way of example, the smart card CD may co-operate with the reader T in a contactless mode using a radio frequency (RF) antenna integrated in the card CD.

Still in the example presently under consideration, a log file LG and at least one predefined rule criterion (or parameter) CR are stored in the non-volatile rewritable memory 10 of the card CD.

In this example, at least one transaction TR that has been carried out by the smart card CD in the past is stored in the log file LG. The log file LG stores log data DLG in association with each transaction TR. By way of example, the log data DLG may be transaction data characterizing the corresponding transaction TR. The log file LG enables the card CD to keep a record of useful data DLG relating to the transactions it carries out, which data, if necessary, can subsequently be consulted, processed, and/or sent by the card CD.

A particular example of such a log file LG in which transactions TR are stored (and more particularly in which log data associated with those transactions is stored) is described below with reference to FIG. 6. By way of example, the log data DLG for storing in the log file LG may comprise at least one of the following: a transaction identifier ID; a time point PT (e.g. a date and/or a time) characterizing the moment at which the transaction was carried out; an amount MT for the transaction; log data DN1 indicating whether the transaction was performed on-line or off-line; log data DN2 indicating whether the issuer EM successfully performed on-line authentication (or validation) of an on-line transaction; and log data DN3 indicating the type of terminal T that co-operated with the card CD during the transaction. Amongst all types of transaction T, mention may be made by way of example of automatic teller machines (ATMs) and payment terminals, with other types of terminal being possible.

Furthermore, the criterion or criteria CR stored in the memory 10 may comprise at least one selection criterion CR1 and/or at least one analysis criterion CR2. Where appropriate, the selection and analysis criteria CR1, CR2 configure the way in which the card performs the method of the invention, as explained below. In the example shown in FIG. 3, the criteria CR stored in the memory 10 comprise two predefined conditions CD1 and CD2, each constituting a selection criterion CR1, together with a condition CD3 constituting an analysis criterion CR2. As already mentioned, other implementations are possible in the ambit of the invention, and the number and nature of selection criteria and of analysis criteria in particular may vary as appropriate.

The criteria CR and the log file LG are described in greater detail below for a particular implementation with reference to FIGS. 4-9.

In a particular implementation, the processor 6 controlled by the computer program PG implements a certain number of modules as shown in FIG. 4, namely: a determination module MD2; a selection module MD4; an analysis module MD6; and a security module MD8.

In this particular example, the determination module MD2 is configured to determine a current point (or position) in time, written PC, during which a current transaction is or is to be carried out by the smart card CD. The term “current point in time” is used to mean a given instant in time at which a current transaction is or is to be carried out by the smart card CD. By way of example, a point in time may be defined by means of a date and/or a time, and more generally by any time data enabling a given position in time to be defined.

Various methods can be used to enable the card CD to determine the current point PC in time during which a current transaction is or is to be carried out by the card CD. In an example described in greater detail below, the determination module MD2 determines the current point PC in time from time data it has received, e.g. from the terminal T. In a variant, the smart card CD includes a unit for calculating the current date and/or time.

In this particular example, the selection module MD4 is configured to select in the log file LG that stores at least one past transaction TR, each (or at least one) transaction TR that has been carried out by the smart card CD during a predefined time period or “window” (written PD) terminating at the current time point PC. Since the time period PD is of fixed duration, it shifts in time so that it always terminates at the current time point PC as determined by the determination module MD2. In other words, the predefined time period PD is a moving time period having its end boundary defined by the current time point PC as determined by the determination module MD2. Each time a new current time period PC is determined by the determination module MD2, the time period PD moves through time so that it always terminates at the current point PC. Example implementations are described below with reference in particular to FIG. 6.

In a particular example, the selection module MD4 is configured to select from the transactions TR stored in the log file LG all of those transactions TR that were carried out during the predefined time period PD.

In a particular example, the selection module MD4 is configured to select from the transactions TR stored in the log file LG, those transactions TR that were carried out during the predefined time period PD and that also satisfy at least one predefined selection criterion (or condition) CR1. By way of example, these selection criteria CR1 are stored in the memory 10 of the card CD. As already mentioned, FIG. 3 shows a particular example in which the selection criteria CR1 comprise two conditions CD1 and CD2.

The risk analysis module MD6 is configured on the basis of log data DLG stored in the log file LG in association with each transaction TR selected by the selection module MD4 to detect whether an abnormal (or suspect) use of the card CD has occurred during said predefined period PD.

The term “abnormal use” is used herein to mean any use of the smart card CD that is judged, in accordance with at least one predefined analysis criterion, as being potentially at risk, fraudulent, or abnormal.

Still in this example, the security module MD8 is configured, in the event of a positive result from the detection by the risk analysis module MD6 (i.e. if an abnormal use of the card CD is detected by the analysis module MD6), to trigger at least security operation of the smart card CD in response to the current transaction TR. Each security operation is configured to make the smart card CD secure in response to the current transaction TR. Examples of such operations are described below with reference to FIGS. 5-9.

The steps performed by the smart card CD in a particular implementation of a security method are described below reference to FIG. 5. For this purpose, the smart card CD executes the computer program PG.

It is assumed that the smart card CD has co-operated with the terminal T to initiate processing of a transaction TR referred to as the “current” transaction. In a variant, the current transaction TR need not yet have been initiated.

In this example, the transaction TR is in compliance with the EMV protocol.

During a determination step S30, the smart card CD determines a current time point PC during which the current transaction TR is or is to be carried out by the smart card CD. By way of example, this current point PC comprises at least one of the date (referred to as the “current” date) and the time (referred to as the “current” time) of the current transaction.

During S32, the smart card CD selects from the log file LG in which at least one past transaction TR is recorded, each (or at least one) transaction TR carried out by the smart card CD during a predefined time period PD terminating at the current time point PC. As mentioned above, this period PD is a moving time window of predefined duration having its end boundary defined by the current time position PC.

In a particular example, the current time point PC is defined by the current date DC=[Feb. 16 2016] and the current time HC=[16:00], and the duration of the time period PD is set at 30 days. As mentioned below, the duration of the time period PD may be adapted, in particular depending on the configuration desired in the light of the type of events or behaviors that it is desired to monitor in the smart card CD.

Thereafter, the smart card CD analyzes (S34) risk (or the transaction) on the basis of at least one item of log data DLG stored in the log file LG associated with each transaction TR selected during S32 in order to detect whether an abnormal (or suspect) use of the smart card CD has taken place during the predefined time period PD. During S34, and by way of example, the smart card CD may detect that an abnormal use of said card CD has taken place during the predefined time period PD on the basis of at least one of the following:
the number of transactions TR selected during S32; and
the total accumulated amount (i.e. the total of the amounts MT) for the transactions TR selected during S32.

For example, during this risk analysis S34, the smart card CD detects that abnormal use has occurred during the predefined time period PD if at least one of the following predefined conditions is satisfied:
the number of transactions selected during the selection S32 reaches at least one first predefined threshold value; and
the total accumulated amount of the transactions TR selected during the selection S32 reaches at least one second predefined threshold value.

If an abnormal use is detected during S34, the smart card CD acts during S36 to trigger at least one security action for the smart card CD in response to the current transaction TR.

Each security operation seeks to make the smart card CD secure with respect to the current transaction TR, and more generally with respect to the use that has been made of the smart card CD over the time period PD. The number and the nature of these security operations may vary as appropriate.

In a particular implementation, said at least one security operation S36 comprises at least one of any of the following:
sending a message (e.g. to the terminal T and/or to the server SV) giving information that said abnormal use has been detected during S34:
modifying at least one operating parameter of the smart card CD;
storing security data in the log file LG, which data is representative of said abnormal use detected during S34; and
refusing to carry out the current transaction TR.

The nature(s) of the operating parameter(s) PR that is/are to be modified where appropriate during S36 may vary depending on circumstances. In general manner, an operating parameter PR configures the way in which the smart card CD processes a transaction TR with an external terminal, such as the reader T in this example. By way of example, the operating parameter PR that is to be modified may be a count stored in the smart card CD. By way of example, such a count may represent the number of off-line transactions that have already been performed by the smart card CD, or indeed the total accumulated amount represented by the off-line transactions that have already been performed by the smart card CD. The parameter PR may also relate to a threshold value for such a count. Modifying the parameter PR may constitute updating the configuration of the smart card CD so as to give rise to a change in the processing of transactions TR by the smart card CD.

A particular implementation is described below with reference to FIGS. 6 to 8. More precisely, the smart card CD performs an implementation of the security method by executing the computer program PG.

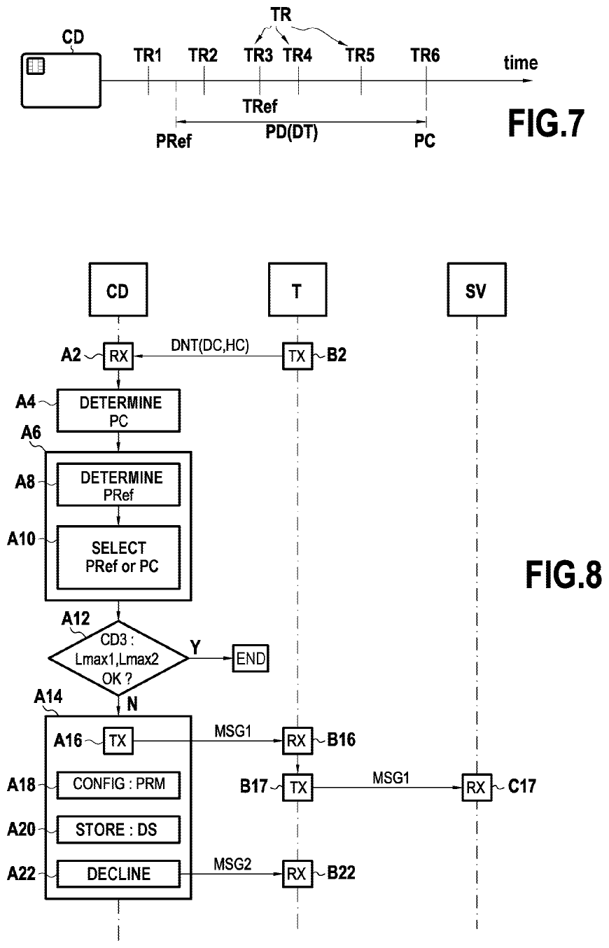

FIG. 7 shows the transactions TR1-TR5 that have been carried out in succession in the past by the smart card CD using the EMV protocol, these transactions being plotted along a time line.

FIG. 6 shows the records concerning these transactions TR1 to TR5 in the log file LG of the smart card CD. More particularly, log data is stored in the log file DLG in association with each transaction TR1-TR5. The log data DLG characterizes the transactions TR1-TR5 that have already been carried out by the smart card CD. In this particular example, the log data DLG stored in the log file LG comprises, in association with each referenced transaction TR, a transaction identifier ID, a time point PT (e.g. a date and/or a time) at which the transaction was carried out, and a transaction amount MT, and possibly at least one of the following: log data DN1 indicating whether the transaction was carried out on-line or off-line, log data DN2 indicating whether authentication (or validation) by the issuer EM took place successfully on-line if the transaction was an on-line transaction, and log data DN3 indicating the type of terminal T that co-operated with the card CD during the transaction. Among possible types of terminal T, mention may be made by way of example of automatic teller machines (ATMs) and payment terminals, other types of terminal also being possible.

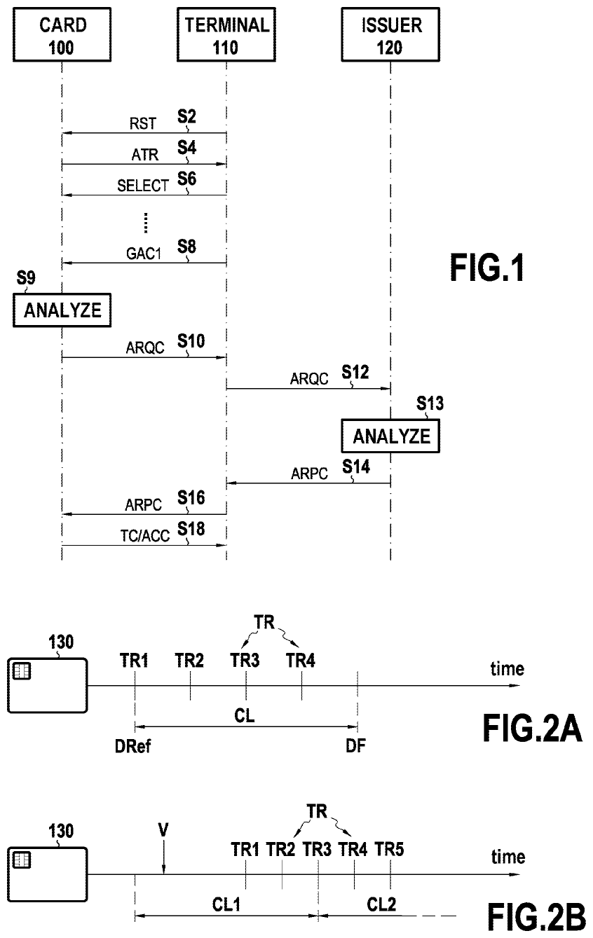

As shown in FIG. 7, it is assumed at this point that the smart card CD, in co-operation with the terminal T, has initiated EMV protocol processing of a new transaction TR6 referred to as the “current” transaction. By way of example, the smart card CD is inserted in the terminal T in order to communicate by contact. In a particular example, it is assumed that the smart card CD has received a first APDU command of the GENERATE AC type, written GAC1, as explained above with reference to step S8 in FIG. 1, and that the smart card CD performs the security method in a particular implementation of the invention in response to this command GAC1. In a variant, the security method is performed at some other stage of the EMV protocol. In yet another variant, the smart card CD performs the security method even when processing of the current transaction TR by the EMV protocol has not yet been initiated.

Steps A4, A6, A12, and A14 as described below with reference to FIG. 8 correspond respectively to the steps S30, S32, S34, and S36 shown in FIG. 5, as performed in a particular implementation of the invention.

During a sending step B2, the terminal T sends time data DNT to the smart card CD which receives it during A2. The time data DNT is representative of a current time point PC. This time data DNT may present any suitable format and in this example comprises the current date DC and the current time HC.

During A4, the smart card CD uses the time data DNT received during A2 to determine the current time point PC during which the current transaction TR6 is to be carried out. In this example, the current point DC is defined by the current date DC and the current time HC when the EMV protocol is initiated between the smart card CD and the terminal T in order to carry out the current transaction TR6. Other techniques for determining the current date and/or time are nevertheless possible.

Thereafter, the smart card CD selects (A6) from the log file LG each transaction TR that was carried out by the smart card CD during the predefined time period PD terminating at the current time point PC as determined during A4. In this example, the time period PD is a time window of predefined duration DT. The value of DT may be adapted depending on the looked-for objectives, as explained below.

More specifically, during selection A6, the smart card CD (and more particularly the selection module MD4) acts in this example to determine the time reference point, written PRef, that corresponds to the beginning of the predefined time period PD (FIG. 7). To do this, in this particular example, the smart card CD calculates the time reference point PRef from the current time point PC and from the predefined duration DT given to the time period PD. More precisely, the smart card CD calculates PRef as follows:

PRef=PC−DT

In this example, the reference point PRef comprises the date and the time of the beginning of the time period PD.

The reference time point PRef may correspond to a transaction previously carried out by the smart card CD.

Still during A6, the smart card CD then selects (A10) each of the transactions TR that is stored in the log file LG and that is later than the reference time point PRef. In a particular example, the selection during A10 includes the transaction TR, if any, that was carried out at the reference time point PRef (there being no transaction recorded at the point PRef in this example).

In this example, the smart card CD determines the moment at which a transaction TR stored in the log file LG was carried out (or processed) on the basis of the time point PT stored in the log file LG in association with the transaction TR concerned. By way of example, PT comprises the date and/or the time of the corresponding transaction TR.

In this particular example, the smart card CD selects during A10 the transactions TR2, TR3, TR4, and TR5 having time points PT (i.e. date and time) that are later than the reference time position PRef. The smart card CD also selects during A10 the current transaction TR6, even though variants are possible in which the current transaction TR is not selected during A10.

The smart card CD may also be configured to apply at least one selection criterion CR1 in order to refine the selection it performs during A10. In a variant, the smart card CD may for example act during A10 to select from the log file LG the most recent transaction TR in the time period PD that satisfies the first predefined condition CD1, and use it as the reference transaction TRef. The term “most recent” is used herein to mean the transaction TR having the time point PT that is the closest to the current point PC. The smart card CD then selects during A10 only each transaction TR carried out by said card CD subsequent to the reference transaction TRef in the predefined time period PD. In a particular implementation, the first condition CD1 comprises at least one of the following conditions:
CD11: the reference transaction TRef is an on-line transaction that was carried out in co-operation with the issuer EM; and
CD12: the reference transaction TRef was an on-line transaction carried out in co-operation with the issuer EM and that was successfully authenticated (or validated) by said issuer EM.

When the above condition CD11 is applied, the smart card CD determines for each transaction TR having its time point PT subsequent to the reference transaction TRef, and on the basis of the associated data DN1, whether said transaction TR was an on-line transaction.

When the above condition CD12 is also applied, the smart card CD determines, for each on-line transaction having its time point PT subsequent to the reference transaction TRef, and on the basis of the corresponding data DN2 in the log file LG, whether said transaction TR was successfully authenticated (or validated) by the issuer EM.

In a particular implementation, the smart card CD applies the condition CD11 but not the condition CD12 during A10. In the example shown in FIG. 6, the transaction TR3 then constitutes the reference transaction TRef (DN1=ON-LINE) such that during A10 the smart card CD selects the transactions TR4 and TR5 in compliance with the condition CD11.

In another implementation, the smart card CD applies the above condition CD12. In the example shown in FIG. 6, the transaction TR3 then likewise constitutes the reference transaction TRef since the associated data DN2 indicates that that on-line transaction was successfully authenticated (or validated) by the issuer EM (DN2=OK). Consequently, during A10, the smart card CD selects the transactions TR4 and TR5 in compliance with the condition CD12.

As mentioned above, the smart card CD may be configured to apply at least one selection criterion CR1 to refine the selection made during A10. The number and the nature of selection criteria CR1 can vary as appropriate. In a particular example, during selection A10, the smart card CD filters the transactions TR stored in the log file LG so as to select only those transactions TR that satisfy at least one second predefined condition CD2.

In a particular example, the second predefined condition CD2 comprises a condition about the type of transaction T with which the smart card CD co-operated during said transaction TR. In the example shown in FIG. 6, the log file LG stores log data DN3 for each transaction TR specifying whether said transaction was carried out in co-operation with a terminal T of a first type TY1 or of a second type TY2. In a particular example, the states TY1 and TY2 indicate respectively that the terminal T was an automatic teller machine (ATM) or was a payment terminal (e.g. a mobile terminal). By way of example, if the condition CD2 is applied, the smart card CD excludes from the selection A10 those transactions TR that took place during the predefined period PD and that do not satisfy the state TY1 (the transaction TR5 is thus excluded in this example).

It can be understood that it is possible to configure the smart card CD so that it applies at least one first condition CD1 and/or at least one second condition CD2 as explained above.

Below in this example it is assumed that the smart card CD applies the condition CD11 and consequently selects the transactions TR4 and TR5 during A10.

During an analysis step A12, the smart card CD (and more particularly its risk analysis module MD6) performs risk analysis (or transaction analysis) on the basis of log data DLG stored in the log file LG in associated with each transaction TR as selected during A6 (specifically TR4 and TR5 in this example), in order to detect whether abnormal (or suspect) use of the smart card CD has occurred during the predefined time period PD.

In this implementation, during said analysis A12, the smart card CD detects whether abnormal use of said card CD has occurred during the predefined time period PD on the basis of at least one of the following:
the number of transactions TR selected during A6; and
the total accumulated amount of the transactions TR selected during A6.

In this example, it is assumed that the number of transactions TR selected during A6 and the total accumulated amount of the transactions TR selected during A6 are both taken into account by the smart card CD when analyzing risk during A12. In the presently-considered example, and as shown in FIG. 6, two transactions TR4 and TR5 are selected during A6 and the total accumulated amount of the transactions TR4 and TR5 amounts to MT4+MT5.

In a particular example, during the risk analysis A12, the smart card CD detects whether abnormal (or suspect) use has taken place during the predefined time period PD in compliance with at least one analysis criterion CR2 as stored in this example in the memory 10. In this example, during the analysis A12, the smart card CD applies the following predefined conditions CD3 as analysis criteria CR2:
CD31: the number of transactions selected during said selection A6 reaches at least a first predefined threshold value Lmax1; and
CD32: the total accumulated amount (MT4+MT5 in this example) of the transactions TR selected during A6 reaches at least a second predefined threshold value Lmax2.

In other words, during analysis A12, the smart card CD detects that abnormal or suspect use has taken place during the predefined time period PD if the conditions CD32 and CD32 are satisfied. The values Lmax1 and Lmax2 are determined depending on specific requirements.

In a variant, only one of the predefined conditions CD31 and CD32 is applied by the smart card CD during the analysis A12.

If no abnormal use is detected during the analysis A12, the security method comes to an end. Under such circumstances, the smart card CD may for example return to normal processing of the transaction using the EMV protocol.

In contrast, if abnormal use is detected during A12, then in A14 the smart card CD triggers at least one security operation for the smart card CD in response to the current transaction TR6. Each security operation is configured to make the smart card CD secure relative to the current transaction TR, and more generally relative to the use made of the smart card CD over the time period PD. The number and the nature of the security operations may vary depending on circumstances.

In this example, the smart card CD acts during A14 to perform at least one of the following operations:
sending (A16) a message MSG1 to the terminal T providing information about said abnormal or suspect use that has been detected. Where appropriate, the terminal T may transmit (B17) the message MSG1 to the remote server SV so that the issuer SV is informed of the abnormal or suspect use as detected as by the smart card CD;
modifying at least one operating parameter PR of the electronic device. As mentioned above, various operating parameters PR of the smart card CD can be modified depending on needs. In general manner, an operating parameter PR configures the way in which the smart card CD processes a transaction TR with the terminal T;
storing (A20) security data DS in the log file LG, which data is representative of said abnormal or suspect use as detected during A12; and
refusing (A22) to authorize the current transaction. By way of example, the smart card CD sends a refusal message MSG2, which is received by the terminal T during B22.

The present invention serves advantageously to protect smart cards, e.g. of the EMV type, effectively against abnormal or suspect behaviors that occur in particular during off-line transactions. A smart card of the invention is thus capable of storing log data in memory relating to the transactions processed by said card over time. On the basis of this log data, the smart card can then analyze the use that is made of the card during a certain time window, i.e. a time window that in this example corresponds to a period of time that immediately precedes the current transaction. It is thus possible to take account of all of the pertinent transactions in each analysis that is undertaken by the smart card, without there being any risk of certain transactions being excluded from the analysis, as happens for example in the security mechanism described above with reference to FIGS. 2A and 2B.

It is possible to set the duration DT of the time period PD as a function of the type of abnormal or unauthorized use that it is desired to detect. In order to mitigate the above-described theft problems, it is possible for example to set the duration DT so that DT=10 minutes (or any value less than 60 minutes or 10 minutes). In contrast, if it is desired to detect abnormal behavior by the authentic bearer (e.g. an abnormal or suspect number of transactions and/or accumulated total expenditure amounts), it is possible for example to set the duration DT such that DT=30 days. In this way, the issuer can monitor the consumption habits of the authentic bearer and, if necessary, can contact the bearer or can take any other appropriate measure.

It is thus possible to configure the smart card so as to trigger a security response adapted to the detected abnormal use. Strengthened security for the smart card against fraudulent use (e.g. in the event of theft) is made possible, for example.

In general manner, the invention serves to provide better monitoring of the use of a smart card, in particular of EMV type, including when the card is used off-line.

A person skilled in the art will understand that the above-described implementations and variants merely constitute non-limiting implementations of the invention. In particular, the person skilled in the art can envisage any adaptation or combination of the above-described implementations and variants for the purpose of responding to some particular need.

1. A security method performed by an electronic device, said method comprising:
determining a current time point during which a current transaction is or is to be carried out by the electronic device;
selecting, from a log file in which at least one past transaction is stored, at least one transaction carried out by said electronic device during a moving time period of predefined duration, said moving time period terminating at the current time point;
analyzing risk from log data stored in the log file in association with each selected transaction in order to detect whether an abnormal use of said electronic device has occurred during said moving time period; and
if so, triggering at least one security operation for the electronic device in response to said current transaction.

2. A method according to claim 1, wherein the current time point comprises at least one of the current date and the current time of the current transaction.

3. A method according to claim 1, wherein determining the current time point comprises receiving time data representative of the current time point from a terminal with which the electronic device is co-operating.

4. A method according to claim 1, wherein said selecting comprises calculating the time point for the beginning of the moving time period from the current time point and from the predefined duration given to said moving time period;
each transaction that is selected being later than the time point for the beginning of the moving time period.

5. A method according to claim 1, wherein, during said selecting, the electronic device:
determines from the log file, and as a reference transaction, the most recent transaction in the moving time period that satisfies at least one first predefined condition; and
selects only the transactions carried out by said electronic device subsequent to said reference transaction in the moving time period.

6. A method according to claim 5, wherein said at least one first predefined condition comprises at least one of the following conditions:
the reference transaction is an “on-line” transaction that was carried out in co-operation with an issuer entity that issued the electronic device; and
the reference transaction is a “on-line” transaction that was successfully authenticated by the issuer entity that issued the electronic device.

7. A method according to claim 1, wherein, during said selecting, the electronic device filters the transactions stored in the log file so as to select only those transactions that satisfy at least one second predefined condition.

8. A method according to claim 7, wherein the at least one second predefined condition comprises a condition about the type of terminal with which the electronic device co-operated during said transaction.

9. A method according to claim 1, wherein, during said analyzing risk, the electronic device detects whether abnormal use of said electronic device has taken place during said moving time period on the basis of at least one of the following:
the number of transactions selected; and
the total accumulated amount of the selected transactions.

10. A method according to claim 9, wherein, during said analyzing risk, the electronic device detects that an abnormal use has occurred during said moving time period if at least one of the following third predefined conditions is satisfied:
the number of transactions selected during said selection reaches a first predefined threshold value; and
the total accumulated amount of the transactions selected said during said selection reaches a second predefined threshold value.

11. A method according to claim 1, wherein said at least one security operation comprises at least one of the following:
sending a message providing information about said detected abnormal use;
modifying at least one operating parameter of the electronic device;
storing, in the log file, security data that represents said detected abnormal use; and
refusing to carry out said current transaction.

12. A method according to claim 1, wherein the electronic device is a smart card.

13. (canceled)

14. A non-transitory computer readable data medium storing a computer program including instructions that when executed by a processor, perform operations comprising:
determining a current time point during which a current transaction is or is to be carried out by an electronic device;
selecting, from a log file in which at least one past transaction is stored, at least one transaction carried out by the electronic device during a moving time period of predefined duration, said moving time period terminating at the current time point;
analyzing risk from log data stored in the log file in association with each selected transaction in order to detect whether an abnormal use of the electronic device has occurred during the moving time period; and
when the abnormal use is detected, triggering at least one security operation for the electronic device in response to the current transaction.

15. An electronic device comprising:
a determination module for determining a current time point during which a current transaction is or is to be carried out by the electronic device;
a selection module for selecting in a log file that stores at least one past transaction, at least one transaction carried out by said electronic device in a moving time period of predetermined duration that terminates at the current time point;
a risk analysis module for detecting, from log data stored in the log file in association with each selected transaction, whether an abnormal use of said electronic device has taken place during said moving time period; and
a security module configured, in the event of a positive result of said detecting by the risk analysis module, to trigger a security operation for the electronic device in response to said current transaction.

16. An electronic device according to claim 15, including a memory in which the log file is stored.

17. An electronic device according to claim 15, wherein the electronic device is a smart card.
